(19) United States
(12) Patent Application Publication
(10) Pub. No.: US 2014/0122367 A1
(43) Pub. Date: May 1, 2014

(54) Social Shipping

(71) Applicant: EBAY INC., San Jose, CA (US)

(72) Inventor: Sandra Lynn Godsey, San Jose, CA (US)

(73) Assignee: eBay Inc., San Jose, CA (US)

(21) Appl. No.: 13/666,687

(22) Filed: Nov. 1, 2012

(51) Int. Cl. G06Q 10/08; G06Q 50/28

(52) U.S. Cl. 705/330

(57) ABSTRACT

A system and method for a social shipping system are described. An item offered by a seller and selected for purchase by a buyer of a marketplace is identified. From a social network of the buyer, at least one local user geographically located within a predetermined distance of an address of the buyer is identified. A single shipping transaction from the seller to the buyer and the at least one local user is generated.

### TECHNICAL FIELD

This application relates generally to the field of computer technology, and in a specific example embodiment, a method and system for social shipping.

### BACKGROUND

Online and offline marketplaces include many sellers listing items fur sale. Buyers buy these items and sellers ship the items to the buyer upon receipt of payment. Many buyers and sellers are located across the country or across many geographical regions. Shipping cost increases with the number of items being shipped separately to multiple shipping destinations, further contributing to cardboard and fuel waste.

Furthermore, greater shipping distance further contributes to greater shipping cost. It typically costs more to ship to a buyer geographically closer to the buyer than to another buyer further away from the seller. Furthermore, aside from shipping cost, shipping duration increases with distance.

### BRIEF DESCRIPTION OF THE DRAWINGS

The present disclosure is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2 shows a block diagram illustrating one example embodiment of a marketplace application;

FIG. 3 shows a block diagram illustrating one example embodiment of a social shipping application;

FIG. 4 shows a block diagram illustrating one example embodiment of a shared shipping engine;

FIG. 5A shows a diagram illustrating one example of multiple shipping transactions from a same seller for the same item to multiple local buyers;

FIG. 5B shows a diagram illustrating one example of a single shipping transaction from a same seller for the same item to multiple local buyers;

FIG. 6A shows a diagram illustrating one example of multiple shipping transactions from a same seller for different items to multiple local buyers;

FIG. 6B shows a diagram illustrating one example of a single shipping transaction from a same seller for different items to multiple local buyers;

FIG. 7A shows a diagram illustrating one example of multiple shipping transactions from different sellers for the same item to multiple local buyers;

FIG. 7B shows a diagram illustrating one example of a single shipping transaction from one seller for the same item to multiple local buyers;

FIG. 8 shows a flow diagram illustrating one example embodiment of a method for a social shipping application;

FIG. 9 shows a flow diagram illustrating one example embodiment of a method for a social shipping application; and

FIG. 10 shows a diagrammatic representation of machine in the example form of a computer system within which a set of instructions may be executed to cause the machine to perform any one or more of the methodologies discussed herein.

### DETAILED DESCRIPTION

Although the present disclosure is described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

A system and method for a social shipping system is described. An item offered by a seller and selected for purchase by a buyer of an online marketplace is identified. While the following descriptions detail an online marketplace, similar social shipping applications may be implemented which incorporate offline marketplaces and shipping events. From a social network of the buyer, at least one local user geographically located within a predetermined distance of an address of the buyer is identified. A single shipping transaction from the seller to the buyer and the at least one local user is generated.

### System Architecture

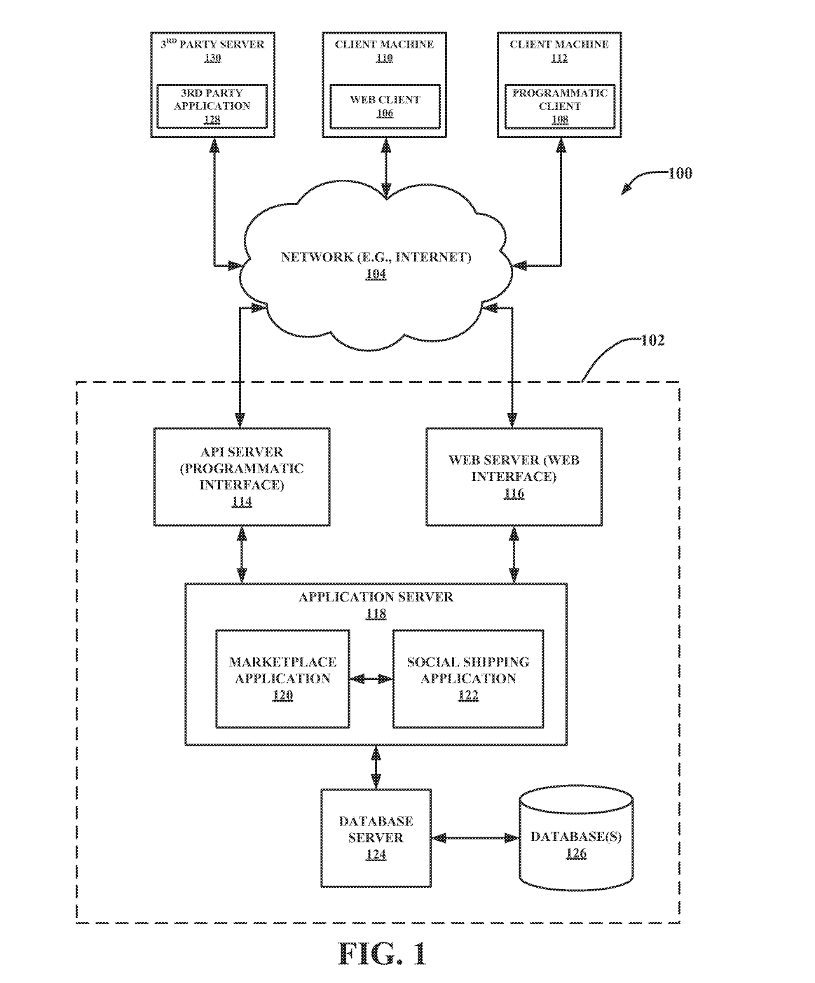

FIG. 1 is a network diagram depicting a network system 100, according to one embodiment, having a client-server architecture configured for exchanging data over a network. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture as an example, other embodiments may include other network architectures, such as a peer-to-peer or distributed network environment.

A data exchange platform, in an example form of a marketplace application 120 and a social shipping application 122, may provide server-side functionality, via a network 104 (e.g., the Internet) to one or more clients. The one or more clients may include users that utilize the network system 100 and more specifically, the marketplace application 120 and the social shipping application 122, to exchange data over the network 104. These transactions may include transmitting, receiving (i.e., communicating) and processing data to, from, and regarding content and users of the network system 100. The data may include, but are not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data such as collection and payment, shipping transactions, shipping label purchases, and real time synchronization of financial journals, among others.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third-party server 130 with a third-party application 128. It can be appreciated that in various embodiments the client machines 110, 112, or third-party server 130 may be associated with a buyer, a seller, a third-party electronic commerce platform, a payment service provider, a shipping service provider, a financial institution system, each in communication with network-based publisher 102 and optionally each other. The buyers and sellers may be any one of individuals, merchants, or service providers, among other things.

Turning specifically to the marketplace application 120 and the social shipping application 122, an application program interface (API) server 114 and a web server 116 are coupled to, and provide programmatic and web interfaces respectively to, one or more application servers 118. The application server 118 hosts one or marketplace applications 120 and the social shipping application 122. The application server 118 is, in turn, shown to be coupled to one or more database servers 124 that facilitate access to one or more data base(s) 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third-party application 128) running on another client machine (e.g., client machine 112 or third-party server 130).

In one embodiment, the marketplace application 120 provides listings and price-setting mechanisms whereby a user may be a seller or buyer who lists or buys goods and/or services (e.g., for sale) published on the marketplace application 120.

In one embodiment, the social shipping application 122 includes a system and a method for forming a virtual fulfillment center for catalog items listed in the marketplace application 120. The social shipping application 122 may store information or apply logic to process information related to items to be shipped, current location of the items, and addresses to which items will be shipped. The social shipping application may use any of a variety of methods to organize the information and make shipping decisions.

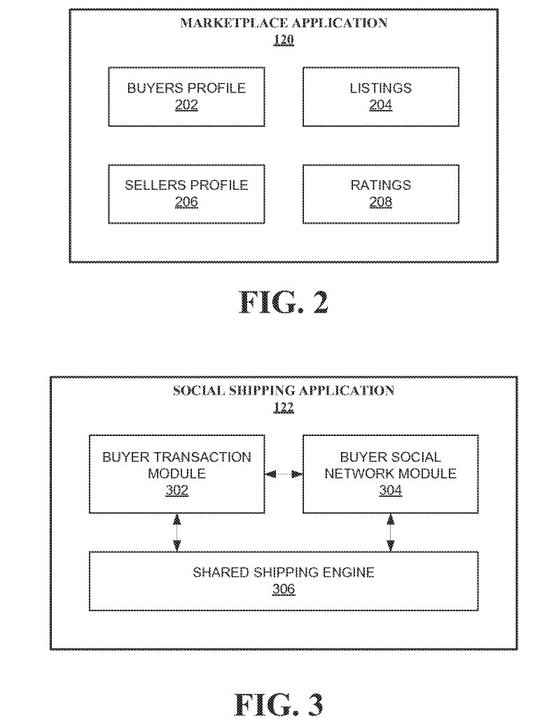

FIG. 2 shows a block diagram illustrating one example embodiment of the marketplace application 120. The marketplace application 120 includes, for example, a buyers profile module 202, a listings module 204, a sellers profile module 206, and a ratings module 208. Other embodiments may include information that is received from users of the marketplace. This information may change with the type of items, transactions, users, buyers, sellers, analytics, and so forth, involved in transactions or otherwise facilitated by the marketplace.

The buyers profile module 202 may be configured to generate and store profiles of buyers of the marketplace application 120. For example, the profiles of the buyers may include names, addresses (including shipping address), and transaction history. Further options may include special shipping arrangements or agreements the buyer has entered into with the marketplace, other buyers, sellers, shipping companies or others. For example, the buyer may have set up to pay a one-time annual fee to cover multiple shipping events.

The listings module 204 may be configured to generate and store listings from the sellers. The listings may identify items for sale in the marketplace application 120 including a description of the items for sale, items price, and shipping information. Other information may be included as well, such as the storage location of items, the proximity to other items, shipping routes, and so forth.

The sellers profile module 206 may be configured to generate and store profiles of sellers of the marketplace application 120. For example, the profiles of the seller may include names, addresses (including shipping address), and transaction history. Further options may include special shipping arrangements or agreements the seller has entered into with the marketplace, buyers, other sellers, shipping companies or others. For example, the seller may offer a one-time annual fee to cover multiple shipping events with buyers.

The ratings module 208 may be configured to generate and store ratings, including feedback ratings of buyers and sellers. For example, a seller may be rated as atop seller if they sell more than a certain amount of items within a period of time. The seller may also be identified as a star seller if their feedback rating level from buyers is higher than a certain level.

The modules illustrated in Marketplace application 120 are examples of the type of information that may be used to implement a social shipping system. There may be more or fewer modules for implementing various schemes.

FIG. 3 shows a block diagram illustrating one example embodiment of the social shipping application 122. The social shipping application 122 may include a buyer transaction module 302, a buyer social network module 304, and a shared shipping engine 306.

The buyer transaction module 302 identifies an item offered by a seller and optionally selected for purchase by a buyer of an online marketplace. In one embodiment, the buyer transaction module 302 determines that the item has been selected for purchase, such as when placed in a shopping cart of the buyer, in the online marketplace and that the buyer has not yet placed an order for the item. In another embodiment, the buyer transaction module 302 determines that the buyer has ordered the item and that a shipping order for the item has not yet been fulfilled. In a further embodiment, the buyer transaction module 302 determines that the buyer may be interested in purchasing an item based on analytics of the buyer's transaction history and browsing history on the online marketplace, or on another online marketplace. In a further embodiment, the buyer transaction module 302 may determine the buyer's interest from analytics of the buyer's social interaction on a social network website. For example, a user of the social network website may be interested in purchasing a particular video game if they have clicked “like” on the name of the particular video game or may have positively commented about the video game on the social network website.

The buyer social network module 304 identifies, from a social network of the buyer, at least one local user geographically located within a predetermined distance of an address of the buyer. For example, the buyer social network module 304 identifies “friends” of the buyer who live within 5 miles of the buyer.

The buyer social network module 304 accesses a social networking website associated with the buyer, and retrieves information of users or friends connected to the buyer. The retrieved information may include the address of each friend of the buyer. In one embodiment, the social networking website may be provided by the online marketplace. In another embodiment, the social networking website may be external to the online marketplace.

The shared shipping engine 306 generates a single shipping transaction from the seller to the buyer and the at least one local user. The single shipping transaction includes generating one shipping package that includes all items for the buyer and the at least one local user. The shared shipping engine 306 may identify a group of items purchased for delivery to a specific geographical area and may act to generate a single shipping event. These items may be from a same seller or different sellers; these items may be a same item or different items. The items are to be shipped to a locale in which other items are to be shipped.

In one embodiment, the shared shipping engine 306 identifies, from the at least one local user, at least one local buyer who has selected for purchase the same item from the same seller, the same item from a different seller, or a different item from the same seller. In another embodiment, the shared shipping engine 306 identifies, from the at least one local user, at least one potential buyer based on the local user's interest and activities on the social networking website and/or the online marketplace. For example, if the local “friend” of the buyer has a history of browsing video games, that local “friend” of the buyer may be identified to invite to purchase another copy of the video game and to share the shipping cost.

In one example embodiment, the single shipping transaction corresponds to the item selected for purchase by the buyer and the same item selected for purchase from the same seller by the local buyer, who may be also referred to as a local friend. Friends may seek to reduce the shipping fees by combining their orders into one shipping event. The multiple items would be sent to one location together avoiding multiple individual shipping events. In another example embodiment, the single shipping transaction corresponds to the item selected for purchase by the buyer and the same item selected for purchase from the different seller by the local buyer. In this example the sellers may coordinate shipping to facilitate social shipping. The coordination may be implemented through use of a common storage location, or by a bundling center which packages the items together for shipping.

In another example embodiment, the single shipping transaction corresponds to the item selected for purchase by the buyer and the different item selected for purchase from the same seller by the local buyer. Here the seller will coordinate the shipping of the different items to a single locale, such as to a single address or a to a drop box located where multiple recipients can access the items.

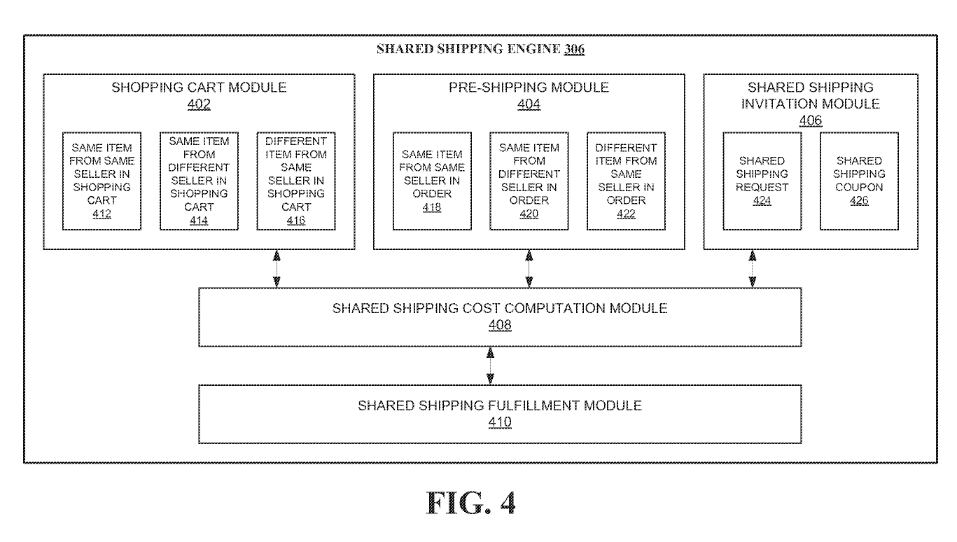

FIG. 4 shows a block diagram illustrating one example embodiment of a shared shipping engine. The shared shipping engine 306 may include a shopping cart module 402, a pre-shipping module 404, a shared shipping invitation module 406, a shared shipping cost computation module 408, and a shared shipping fulfillment module 410.

The shopping cart module 402 includes a first shopping cart module 412, a second shopping cart module 414, and a third shopping cart module 416. Each module is associated with a type of social shipping, such as common item, common seller, or other. Some embodiments may have one or more shopping cart modules. These examples use the shopping cart model, however, the social shipping application may be implemented in any marketplace where items are selected for purchase by buyers.

The first shopping cart module 412 may identify other local buyers who placed the same item from the same seller in their corresponding shopping carts of the online marketplace and who have not yet placed orders for the items in their corresponding shopping carts. The local buyers may be socially connected with the buyer or may be unrelated at this time.

The second shopping cart module 414 may identify other local buyers who placed the same item from different sellers in their corresponding shopping carts of the online marketplace and who have not yet placed orders for the items in their corresponding shopping carts.

The third shopping cart module 416 may identify other local buyers who placed a different item from the same seller in their corresponding shopping carts of the online marketplace and who have not yet placed orders for the items in their corresponding shopping carts.

The pre-shipping module 404 includes a first pre-shipping module 418, a second pre-shipping module 420, and a third pre-shipping module 422.

The first pre-shipping module 418 may identify other local buyers who have ordered the same item from the same seller and whose shipping orders for their corresponding items have not yet been fulfilled.

The second pre-shipping module 420 may identify other local buyers who have ordered the same item from different sellers and whose shipping orders for their corresponding items have not yet been fulfilled.

The third pre-shipping module 422 may identify other local buyers who have ordered different items from the same seller and whose shipping orders for their corresponding items have not yet been fulfilled.

The shared shipping invitation module 406 may generate a request to share shipping cost with the at least local user or other local buyers. The shared shipping invitation module 406 includes a shared shipping request module 424 and a shared shipping coupon 426. The shared shipping request module 424 may generate an invitation to local users of the buyer to purchase the same item from the buyer, a different item from the same seller, and split or share the shipping cost. The shared shipping invitation module 406 may generate shared shipping coupon 426 from the seller to the at least local user, the other local users, or the buyer.

A shared shipping request may be sent to potential buyers and/or buyers by a seller, a buyer, a potential buyer, a shipping service or other party. The request may identify the shipping rates for one and multiple buyers for shipping within a given locale. For example, the shipping rates may be provided for 1-2, 3-5, 6-10 buyers of a product. Similarly, the shipping rates may be provided within multiple radii of a central place, such as the location of one buyer, for example a first rate or set of rates for a first radius, such as 5 kilometers, and a second rate or set of rates for a second radius; the fee differential allowing for the distance to share the goods. For cross-border trade items, such as items from Japan to the US, the social shipping allows buyers to streamline shipping and reduce fees.

A shared shipping request may be sent form a buyer to others in their social network to invite them to purchase a same product and save on shipping. The original buyer may see a savings on the shipping when multiple other buyers join in the same shipping event.

A shipping service may send shipping requests to multiple potential buyers to encourage group shipping during rush and busy seasons or to implement efficiencies. The shipping service may coordinate a group shipping of users based on social network graphs for one or more users. The intersection of these graphs may be used to calculate shipping optimizations and make suggested shipping options. The shipping service may analyze shipping requests and provide reduces rates when a buyer is willing to delay their shipment to incorporate their ordered item into a group shipping event.

The shared shipping cost computation module 408 may determine a shipping cost share for each buyer from the single shipping transaction. The shipping cost share may be based on the item corresponding to each buyer.

The shared shipping fulfillment module 410 may determine a common shipping address for the single shipping transaction for the buyer and the other local buyers.

### Example Scenarios of Social Shipping Applications

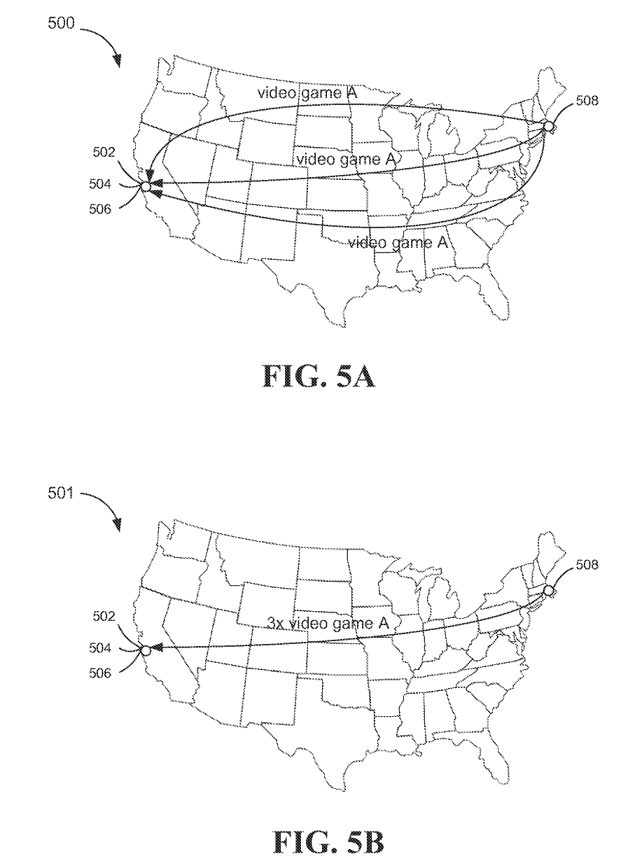

FIG. 5A shows a diagram illustrating one example 500 of multiple shipping transactions from a same seller for the same item to multiple local buyers. Buyers 502, 504, 506 are friends who live in the same street or neighborhood. Buyer 502 placed an order for a video game A from a seller 508. Unbeknownst to the buyer 502, buyers 504 and 506 respectively also placed their own order for the same video game A from the same seller 508. As such, each buyer generates his or her own shipping transaction (e.g., one shipping package per buyer).

Thus, three separate shipping orders are generated for buyers 502, 504, and 506 for the same item, video game A, shipped from the same seller 508. Separate multiple shipping packages result in redundant shipping cost, shipping material, and shipping time.

FIG. 5B shows a diagram illustrating one example 501 of a single shipping transaction from a same seller for the same item to multiple local buyers. The social shipping application 122 determines that other local buyers 504, 506 from the social network of buyer 502 are also interested in purchasing the video game A. As previously described, the social shipping application 122 determines the other local buyers' purchase interest by looking at their corresponding shopping cart, their social network profile, their shopping and browsing history on the online marketplace, among others. For example, the social shipping application 122 may identify other local buyers who have placed the video game A in their shopping cart but who have not yet ordered. In another example, the social shipping application 122 may identify other local buyers who have ordered or pre-ordered the video game A where seller 508 has not yet shipped the video game A (e.g., processing fulfillment, or prior to video game A release date).

Once the social shipping application 122 determines that other local buyers 504, 506 from the social network of buyer 502 are also interested in purchasing the video game A, the social shipping application 122 may generate an invitation to share the shipping cost from seller 508 for the same item, video game A. Upon acceptance of the other local buyers 504, 506, the social shipping application 122 generates a single combined shipping transaction from seller 508 to a shipping address agreed upon by buyers 502, 504, and 506. For example, buyers 502, 504, and 506 may agree to have the video game A shipped to the residence address of buyer 502 where buyers 504 and 506 may later pick up their corresponding copy of video game A upon receipt at the residence address of buyer 502. A confirmation of the receipt may be generated for buyers 504 and 506.

The social shipping application 122 also computes the respective share cost of each buyer 502, 504, 506 for video game A. In the present example, the share cost of each buyer 502, 504, 506 is the cost of one item, video game A, plus one third of the single shipping transaction cost to buyer 502.

In another embodiment, the social shipping application 122 may also generate a coupon for buyers 504 and 506 to join in the shipping transaction with buyer 502.

Thus, a single shipping transaction comprising three copies of the same item, video game A, is generated for buyers 502, 504, and 506 and shipped from the same seller 508. The single shipping transaction eliminates redundant shipping cost, shipping material, and shipping time.

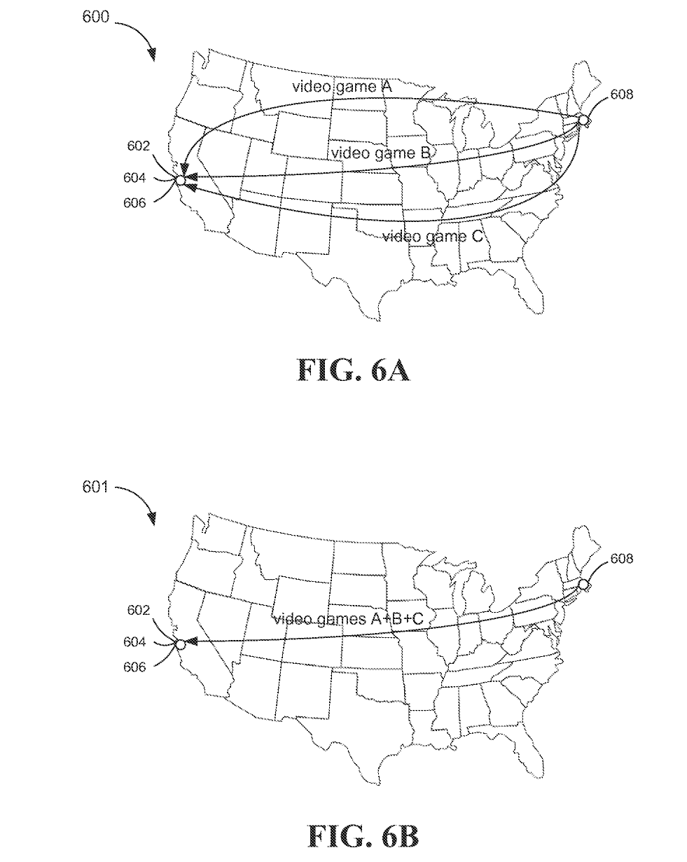

FIG. 6A shows a block diagram illustrating one example of multiple shipping transactions from a same seller for different items to multiple local buyers. Buyers 602, 604, 606 are friends who live in the same street or neighborhood. Buyer 602 placed an order for video game A from a seller 608. Unbeknownst to the buyer 602, buyers 604 and 606 respectively also placed their own order for different video games, video games B and C, from the same seller 608. As such, each buyer generates his or her own shipping transaction (e.g., one shipping package per buyer).

Thus, three separate shipping orders are generated for buyers 602, 604, and 606 for the different items, video games A, B, and C, shipped from the same seller 608. Again, separate multiple shipping packages result in redundant shipping cost, shipping material, and shipping time.

FIG. 6B shows a block diagram illustrating one example 601 of a single shipping transaction from a same seller for different items to multiple local buyers. The social shipping application 122 determines that other local buyers 604, 606 from the social network of buyer 602 are also interested in purchasing from the same seller 608. As previously described, the social shipping application 122 determines the other local buyers' purchase interest by looking at their corresponding shopping cart, their social network profile, their shopping and browsing history on the online marketplace, among others. For example, the social shipping application 122 may identify other local buyers who have placed different items, video games B and C, from seller 608 in their shopping cart but who have not yet ordered. In another example, the social shipping application 122 may identify other local buyers who have ordered or pre-ordered other items, video games B and C, from the same seller 608 who has not yet shipped the other items.

Once the social shipping application 122 determines that other local buyers 604, 606 from the social network of buyer 602 are also interested in purchasing from the same seller 608, the social shipping application 122 may generate an invitation to share the shipping cost from seller 608 for the different video games A, B, and C. Upon acceptance of the other local buyers 604, 606, the social shipping application 122 generates a single combined shipping transaction from seller 608 to a shipping address agreed upon by buyers 602, 604, and 606. The social shipping application 122 also computes the respective share cost of each buyer 602, 604, and 606 for video games A, B, and C. In the present example, the share cost of buyer 602 is the cost of video game A plus one-third of the single shipping transaction cost to buyer 602. The share cost of buyer 604 is the cost of video game B plus one-third of the single shipping transaction cost to buyer 602. The share cost of buyer 606 is the cost of video game C plus one-third of the single shipping transaction cost to buyer 602.

In another embodiment, the social shipping application 122 may also generate a coupon for buyers 604 and 606 to join in the shipping transaction with buyer 602.

Thus, a single shipping transaction comprising three different items, video games A, B, and C, is generated for buyers 602, 604, and 606 and shipped from the same seller 608. This single shipping transaction also eliminates redundant shipping cost, shipping material, and shipping time.

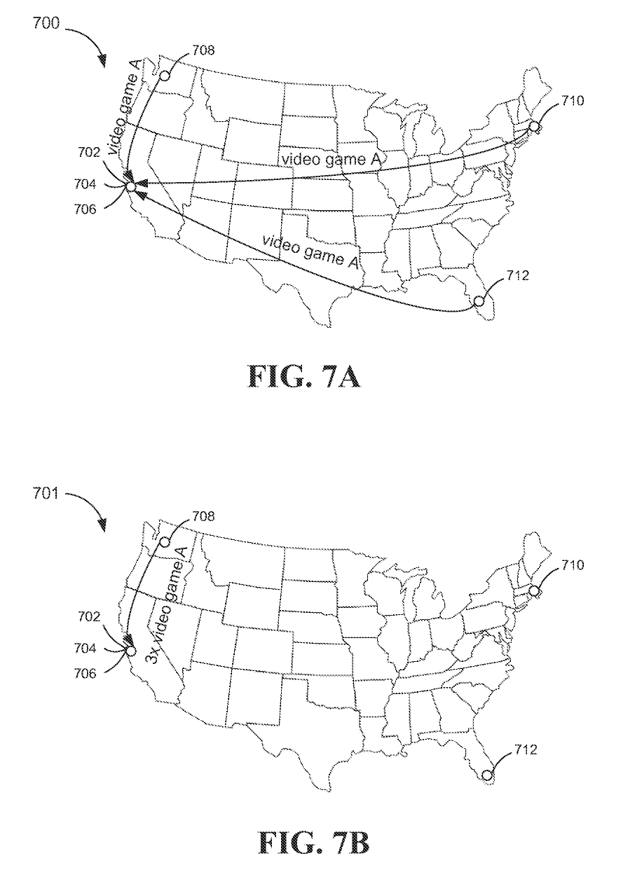

FIG. 7A shows a block diagram illustrating one example 700 of multiple shipping transactions from different sellers for the same item to multiple local buyers. Buyers 702, 704, 706 are friends who live in the same street or neighborhood. Buyer 702 places an order for a video game A from a seller 708. Unbeknownst to the buyer 702, buyers 704 and 706 also placed their own order for the same video game A respectively, from sellers 710 and 712. As such, each buyer generates his or her own shipping transaction (e.g., one shipping package per buyer).

Thus, three separate shipping orders are generated for buyers 702, 704, and 706 for the same item, video game A, shipped respectively from the different sellers 708, 710, and 712. Separate multiple shipping packages of the same item, video game A, result in redundant shipping cost, shipping material, and shipping time.

FIG. 7B shows a block diagram illustrating one example 701 of a single shipping transaction from one seller for the same item to multiple local buyers. The social shipping application 122 determines that other local buyers 704, 706 from the social network of buyer 702 are also interested in purchasing the video game A. As previously described, the social shipping application 122 determines the other local buyers' purchase interest by looking at their corresponding shopping cart, their social network profile, their shopping and browsing history on the online marketplace, among others. For example, the social shipping application 122 may identify other local buyers who have placed the video game A in their shopping cart but who have not yet ordered. In another example, the social shipping application 122 may identify other local buyers who have ordered or pre-ordered the video game A where sellers 710 and 712 have not yet shipped the video game A (e.g., processing fulfillment, or prior to video game A release).

Once the social shipping application 122 determines that other local buyers 704, 706 from the social network of buyer 702 are also interested in purchasing the video game A, the social shipping application 122 may generate an invitation to share the shipping cost from seller 708 (or a seller with the lowest price) for the same item, video game A. For example, the social shipping application 122 may notify buyers 704, 706 that buyer 702 is about to place an order for video game A and request whether buyers 704, 706 would also like to purchase an additional copy of video game A to be added to the same shipping transaction with buyer 702. Upon acceptance of the other local buyers 704, 706, the social shipping application 122 generates a single combined shipping transaction from seller 708 to a shipping address agreed upon by buyers 702, 704, and 706. The social shipping application 122 also computes the respective share cost of each buyer 702, 704, and 706 for video game A. In the present example, the share cost of each buyer 702, 704, and 706 is the cost of one item, video game A plus one-third of the single shipping transaction cost to buyer 702.

In another embodiment, the social shipping application 122 may also generate a coupon for buyers 704 and 706 to join in the shipping transaction with buyer 702.

Thus, a single shipping transaction comprising three copies of the same item, video game A, is generated for buyers 702, 704, and 706 and shipped from the same seller 708 instead of sellers 710 and 712 (assuming seller 708 has the lowest price). Again, this single shipping transaction eliminates redundant shipping cost, shipping material, and shipping time.

### Example Operation of Social Shipping Application

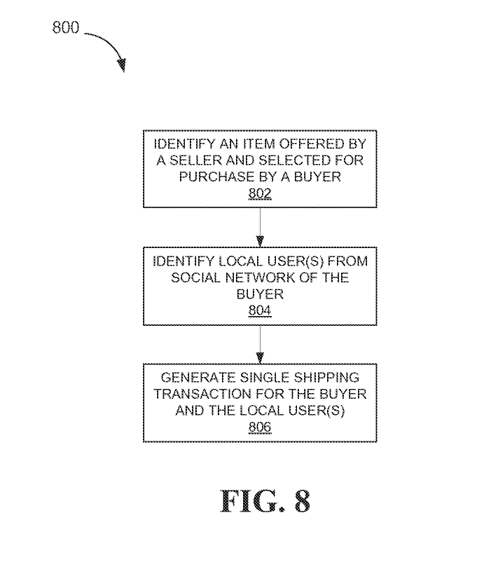

FIG. 8 shows a flow diagram illustrating one example embodiment of a method 800 for a social shipping application. At operation 802, the social shipping application 122 of FIG. 1 identifies an item offered by a seller and selected for purchase by a buyer of an online marketplace. In one embodiment, the buyer transaction module 302 of FIG. 3 identifies the item offered by the seller and selected for purchase by the buyer of the online marketplace.

At operation 804, the social shipping application 122 of FIG. 1 identifies, from a social network of the buyer, at least one local user geographically located within a predetermined distance of an address of the buyer. In one embodiment, the buyer social network module 304 of FIG. 3 identifies, from the social network of the buyer, at least one local user geographically located within the predetermined distance of the address of the buyer.

At operation 806, the social shipping application 122 of FIG. 1 generates a single shipping transaction from the seller to the buyer and the at least one local user. In one embodiment, the shared shipping engine of FIG. 3 generates the single shipping transaction from the seller to the buyer and the at least one local user.

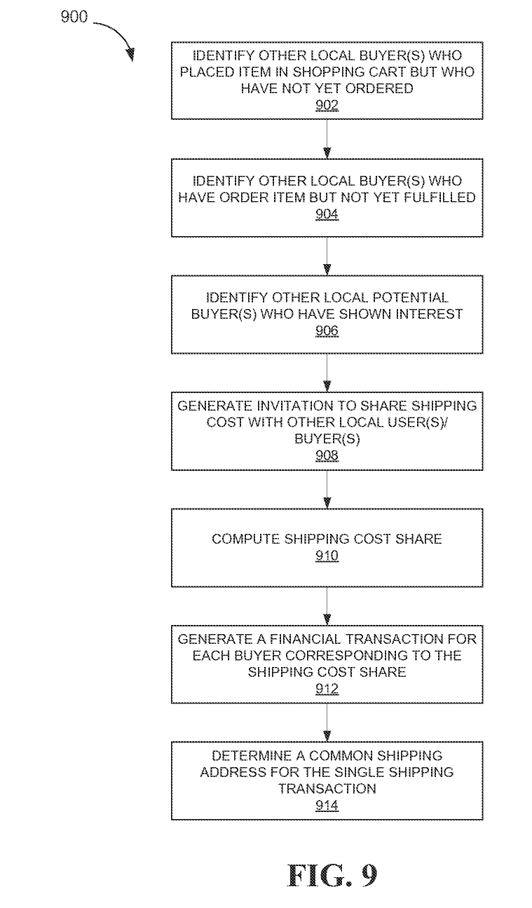

FIG. 9 shows a flow diagram illustrating one example embodiment of a method 900 for a social shipping application. At operation 902, the social shipping application 122 of FIG. 1 identifies other local buyer(s) who placed an item in the shopping cart but have not yet ordered. In one embodiment, the shopping cart module 402 of FIG. 4 identifies other local buyer(s) who placed an item in the shopping cart but have not yet ordered.

At operation 904, the social shipping application 122 of FIG. 1 identifies other local buyer(s) who have ordered an item but the shipping order for the corresponding item has not yet been fulfilled. In one embodiment, the pre-shipping module 404 of FIG. 4 identifies other local buyer(s) who have ordered an item but the shipping order for the corresponding item has not yet been fulfilled. In an alternate embodiment, the flow may identify other local potential buyers based on their social interaction or connection through the social network with a local buyer or potential buyer. An invitation is sent to one or more of these local buyers to participate in a social shipping event.

At operation 906, the social shipping application 122 of FIG. 1 identifies other local users relative to the buyer, other local potential buyer(s) who have shown an interest fur the same item or the same seller. In one embodiment, the shopping cart module 402 of FIG. 4 identifies other local users relative to the buyer, other local potential buyer(s) who may be interested or have shown an interest fur the same item or the same seller.

At operation 908, the social shipping application 122 of FIG. 1 generates an invitation to share shipping costs with the other local buyer(s), other local potential buyer(s), and other local users. In one embodiment, the shopping cart module 402 of FIG. 4 generates the invitation to share shipping costs with the other local buyer(s), other local potential buyer(s), and other local users.

At operation 910, the social shipping application 122 of FIG. 1 computes the respective cost for each buyer, including the respective item cost and share of shipping cost. In one embodiment, the shopping cart module 402 of FIG. 4 computes the respective cost for each buyer, including the respective item cost and share of shipping cost.

At operation 912, the social shipping application 122 of FIG. 1 generates a financial transaction for each buyer corresponding to the shipping cost share. In one embodiment, the shopping cart module 402 of FIG. 4 generates the financial transaction for each buyer corresponding to the shipping cost share.

At operation 914, the social shipping application 122 of FIG. 1 determines a shipping address for the single shipping transaction. In one embodiment, the shopping cart module 402 of FIG. 4 determines the shipping address for the single shipping transaction. Social shipping applications may analyze historical shipping groupings and routes to implement efficiencies. Such as where multiple group social shipping events occur in one locale or geographically defined area this may be an area for further combinations by connecting multiple social networks. The social shipping application may identify these potential groupings and further reduce shipping fees for users.

In some embodiments a buyer may purchase an item at a local store, such as in person or through a mobile application, where the item is to be delivered to the buyer's address, Similar social shipping applications may be implemented to combine multiple orders or items into a shared social shipping event. For example, where neighbors are buying large ticket items from a local appliance store, buyers with a social connection may invite each other to combine delivery into a shared shipping event, and reduce the delivery and shipping fees. The local marketplace may connect the buyers through their identified social networks or through a loyalty card program. The shipping costs are allocated among the buyers, such as evenly or with preferential allocation to the inviting buyer.

### Example Computer System

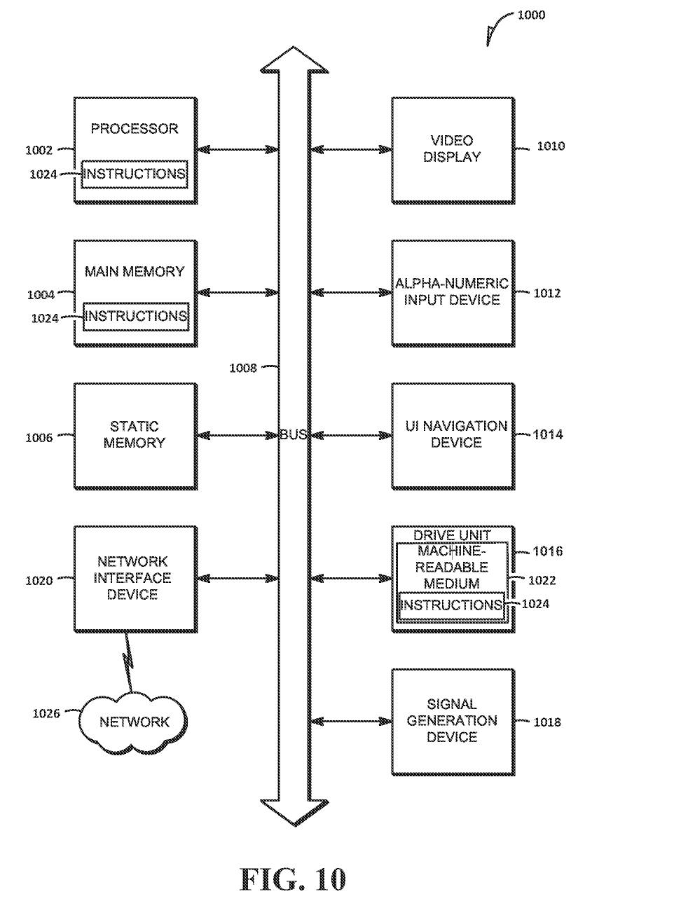

FIG. 10 shows a diagrammatic representation of a machine in the example form of a computer system 1000 within which a set of instructions 1024 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, white only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

The disk drive unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, with the main memory 1004 and the processor 1002 also constituting machine-readable media.

The instructions 1024 may further be transmitted or received over a network 1026 via the network interface device 1020 utilizing any one of a number of well-known transfer protocols (e.g., HTTP).

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions 1024. The term “machine-readable medium” shall also be taken to include any medium that is capable of storing, encoding or carrying a set of instructions for execution by the machine and that cause the machine to perform any one or more of the methodologies of the present disclosure, or that is capable of storing, encoding or carrying data structures utilized by or associated with such a set of instructions. The term “machine-readable medium” shall accordingly be taken to include, but not be limited to, solid-state memories, optical media, and magnetic media.

### Modules, Components and Logic

Certain embodiments are described herein as including logic or a number of components, modules, or mechanisms. Modules may constitute either software modules (e.g., code embodied (1) on anon-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured. (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed:

1. A social shipping system comprising:
a buyer transaction module configured to identify an item offered by a seller and selected for purchase by a buyer of an online marketplace;
a buyer social network module configured to identify, from a social network of the buyer, at least one local user geographically located within a predetermined distance of an address of the buyer; and
a shared shipping engine configured to generate a single shipping transaction from the seller to the buyer and the at least one local user.

2. The social shipping system of claim 1, wherein the buyer transaction module is configured to determine that the item has been placed in a shopping cart of the buyer in the online marketplace and that the buyer has not yet placed an order for the item.

3. The social shipping system of claim 1, wherein the buyer transaction module is configured to determine that the buyer has ordered the item and that a shipping order for the item has not yet been fulfilled.

4. The social shipping system of claim 1, wherein the shared shipping engine is configured to identify, from the at least one local user, at least one local buyer who has selected for purchase a same item from a same seller, the same item from a different seller, or a different item from the same seller.

5. The social shipping system of claim 4, wherein the single shipping transaction corresponds to the item selected for purchase by the buyer and the same item selected for purchase from the same seller by the local buyer.

6. The social shipping system of claim 4, wherein the single shipping transaction corresponds to the item selected for purchase by the buyer and the same item selected for purchase from the different seller by the local buyer.

7. The social shipping system of claim 4, wherein the single shipping transaction corresponds to the item selected for purchase by the buyer and the different item selected for purchase from the same seller by the local buyer.

8. The social shipping system of claim 4, wherein the shared shipping engine further comprises:
a shopping cart module configured to identify other local buyers who placed the same item from the same seller, the same item from the different seller, or the different item from the same seller in their corresponding shopping carts of the online marketplace and who have not yet placed orders for the items in their corresponding shopping carts;
a pre-shipping module configured to identify other local buyers who have ordered the same item from the same seller, the same item from the different seller, or the different item from the same seller, and whose shipping orders for their corresponding items have not yet been fulfilled; and
a shared shipping invitation module configured to generate a request to share shipping cost with the at least one local user or other local buyers.

9. The social shipping system of claim 8, wherein the shared shipping invitation module is configured to generate a shared shipping coupon from the seller to the at least one local user, other local users, or the buyer.

10. The social shipping system of claim 8, further comprising:
a shared shipping cost computation module configured to determine a shipping cost share for each buyer from the single shipping transaction.

11. The social shipping system of claim 8, further comprising:
a shared shipping fulfillment module configured to determine a common shipping address for the single shipping transaction for the buyer and the other local buyers.

12. A computer-implemented method for a social shipping system comprising:
identifying an item offered by a seller and selected for purchase by a buyer of a marketplace;
identifying, from a social network of the buyer, at least one local user geographically located within a predetermined distance of an address of the buyer; and
generating a single shipping transaction from the seller to the buyer and the at least one local user.

13. The computer-implemented method of claim 12, further comprising:
determining that the item has been placed in a shopping cart of the buyer in the marketplace and that the buyer has not yet placed an order for the item; and
determining that the buyer has ordered the item and that a shipping order for the item has not yet been fulfilled.

14. The computer-implemented method of claim 12, further comprising:
identifying, from the at least one local user, at least one local buyer who has selected for purchase a same item from a same seller, the same item from a different seller, or a different item from the same seller.

15. The computer-implemented method of claim 14, wherein the single shipping transaction corresponds to the item selected for purchase by the buyer and the same item selected for purchase from the same seller by the local buyer.

16. The computer-implemented method of claim 14, wherein the single shipping transaction corresponds to the item selected for purchase by the buyer and the same item selected for purchase from the different seller by the local buyer.

17. The computer-implemented method of claim 14, wherein the single shipping transaction corresponds to the item selected for purchase by the buyer and the different item selected for purchase from the same seller by the local buyer.

18. The computer-implemented method of claim 14, further comprising:
identifying other local buyers who placed the same item from the same seller, the same item from the different seller, or the different item from the same seller in their corresponding shopping carts of the marketplace and who have not yet placed orders for the items in their corresponding shopping carts;
identifying other local buyers who have ordered the same item from the same seller, the same item from the different seller, or the different item from the same seller, and whom shipping orders for their corresponding items have not yet been fulfilled; and
generating an invitation to share shipping cost with the at least one local user or other local buyers.

19. The computer-implemented method of claim 18, further comprising:
computing a shipping cost share for each buyer from the single shipping transaction; and
determining a common shipping address for the single shipping transaction for the buyer and the other local buyers.

20. A non-transitory computer-readable storage medium storing a set of instructions that, when executed by a processor, cause the processor to perform operations, comprising:
identifying an item offered by a setter and selected for purchase by a buyer of an marketplace;
identifying, from a social network of the buyer, at least one local user geographically located within a predetermined distance of an address of the buyer; and
generating a single shipping transaction from the seller to the buyer and the at least one local user.
